(19) United States
(12) Patent Application Publication
(10) Pub. No.: US 2018/0210399 A1
(43) Pub. Date: Jul. 26, 2018

(54) WATCH BAND INSERT FOR POSITIONING WATCH FACE ON THE INTERIOR SIDE OF A PERSON'S FOREARM

(71) Applicant: John Luke, JR., Kitty Hawk, NC (US)

(72) Inventor: John Luke, JR., Kitty Hawk, NC (US)

(21) Appl. No.: 15/875,137

(22) Filed: Jan. 19, 2018

Related U.S. Application Data
(60) Provisional application No. 62/449,644, filed on Jan. 24, 2017.

(51) Int. Cl. G04B 37/14; G04B 47/06

(52) U.S. Cl. CPC G04B 37/1486; G04B 47/063

(57) ABSTRACT

An insert for a watch that enables the wrist watch to be positioned on the forearm of a person such that the main body and face of the wrist watch is disposed adjacent an inner side or edge of the forearm in a convenient line of sight for the person wearing the wrist watch. The insert includes a web and a pair of flanges extending from the web. The insert is designed to be attached to the watch such that the web and flanges form an interface between the wrist watch and a person's forearm for securely stationing the main body and face of the watch on the inner side or edge of the forearm.

### FIELD OF THE INVENTION

The present invention relates to accessories for wrist watches and more particularly to an accessory for a running watch that positions the face of the running watch adjacent the inner side or edge of the forearm.

### BACKGROUND

Running watches vary from the simplistic to the relatively sophisticated. In either case, running watches provide a runner with valuable information such as, for example, time elapsed, distance covered, speed, distance splits, biometric information, and even position based on GPS data. The problem faced by a runner is not having access to this information but rather the problem relates to the inconvenience and difficulties in quickly and clearly discerning the information being provided by the running watch. It is not uncommon to see a runner repeatedly lifting the forearm bearing the running watch and rotating the forearm so that he or she can see the data or information being displayed on the watch face. Over a significant distance, this amounts to a lot of forearm lifting and rotating, not to mention the difficulties of quickly and clearly reading and comprehending the data and information being furnished on the watch face. This is all because the face of the watch is not located in the normal line of sight of the runner. Running watches, like conventional wrist watches, are designed for the main body of the watch to be positioned and disposed on the upper surface of the forearm. In a running configuration, the upper surface of the forearm is normally inclined outwardly. This is why we see runners continuously lifting the forearm bearing the watch and rotating the forearm and watch clockwise so that the data and information on the face of the watch can be quickly and easily discerned.

Therefore, there has been and continues to be a need for a device that enables the face of the running watch to be located about the forearm in a convenient location which obviates the need for the continuous rotation of the forearm by the runner to discern information being communicated by the running watch.

### SUMMARY OF THE INVENTION

The present invention relates to an insert that is coupled to a running watch and forms an interface between the main body of the watch and the person's forearm which enables the main body of the watch to be securely positioned and held on the inner side or edge of the forearm in a convenient line of sight for the person wearing the watch.

In one particular embodiment, the present invention includes an insert that includes a web and a pair of flanges extending from the web. The flanges include openings for enabling watch band segments to be inserted therethrough. This enables the main body of the watch to be disposed on the outer surface of the insert while the band segments extend along outer surfaces of the flanges and into and through the openings in terminal end portions of the flanges. When the band segments are fastened, the flanges extend in general parallel relationship across the upper and lower surfaces of the forearm such that the main body of the watch is disposed adjacent the inner edge or side of the forearm where the face of the watch is easily seen by the person wearing the insert and watch.

Other objects and advantages of the present invention will become apparent and obvious from a study of the following description and the accompanying drawings which are merely illustrative of such invention.

### BRIEF DESCRIPTION OF DRAWINGS

FIG. 1 is a perspective view of the watch band insert.

FIG. 2 is a top plan view of the insert.

FIG. 3 is an end elevational view of the insert.

FIG. 4 is a sectional view taken through the line IV-IV of FIG. 3.

FIG. 5 is a perspective view of a combination insert and watch wherein the watch is secured to the insert.

FIG. 6 is a view illustrating the insert attached to the forearm of a person.

FIG. 7 is a perspective view of a runner wearing the insert and associated watch and showing the main body of the watch being disposed in the runner's line of sight.

### DESCRIPTION OF EXEMPLARY EMBODIMENT

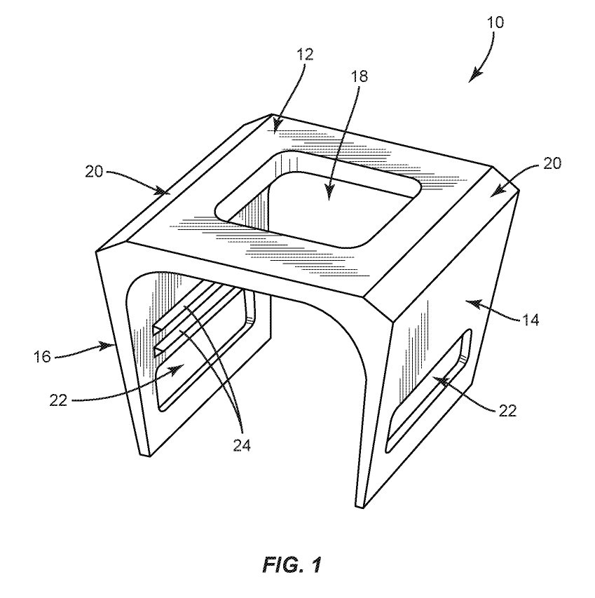

With further reference to the drawings, particularly FIG. 1, the insert or interface of the present invention is shown therein and indicated generally by the numeral 10. The terms “insert” and “interface” are used interchangeably herein. Insert 10 can be constructed of various materials. In some embodiments, the insert 10 can be constructed of at least slightly pliable plastic or rubber material such that the insert can easily conform to a person's forearm.

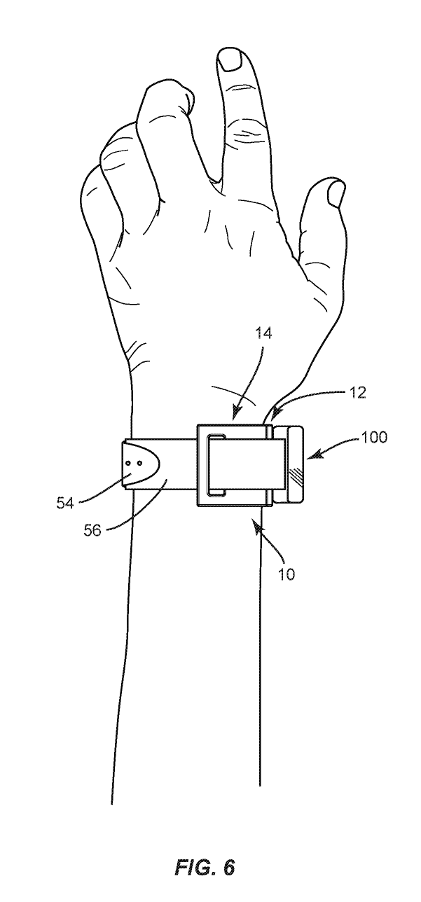

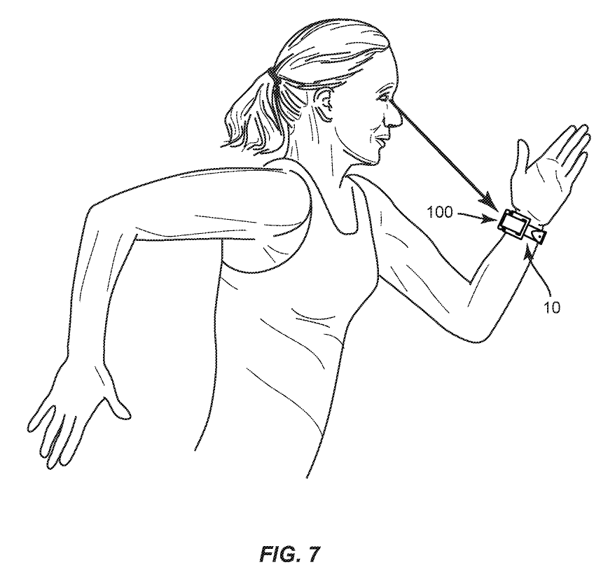

Viewing the insert 10 in more detail, the same comprises a web or pad 12 and a pair of flanges or extensions 14 and 16 that extend from the web 12. Note the barbs 24 disposed on the inner surface of the flanges 14 and 16. The barbs 24 hold the insert or interface 10 in place by compressing slightly into the skin of the forearm. Together the web 12 and flanges 14 and 16 form a generally U-shaped structure that, as described below, is designed to form an interface between the forearm and a watch and to position the face or main body 50 of the watch 100 adjacent the inner side or edge of the forearm (See FIGS. 6 and 7) in a convenient line of sight of the person wearing the watch. In some cases, the web is referred to as a pad and the flanges are referred to as extensions.

Web 12 includes an outer surface for engaging and supporting the back of the watch. The outer surface of the web 12 can assume various shapes and configurations. In the exemplary embodiment shown herein, the outer surface of the web 12 assumes a generally square or rectangular configuration. An opening 18 is provided in the web 12. This permits biometric data or information to be communicated from a person's arm to the main body (or housing) of the watch. On each side of the web 12, there is provided a beveled transition edge 20. As seen in FIG. 1, the transition edge 20 forms a transition between the outer surface of the web 12 and the flanges 14 and 16.

Formed about a terminal end portion of the flanges 14 and 16 is a band opening 22. Band openings 22 enable the two segments of a watch band to be threaded therethrough effectively coupling the insert 10 to the watch. As is appreciated from the drawings, the insert 10 effectively forms a saddle that underlies the main body 50 of the watch 100 and portions of the band segments 54, 56 that extend therefrom. See FIG. 5. The term “main housing” or “main body”, as used herein, refers to the housing disposed between the band segments and which houses the inner workings and mechanisms of the watch 100. Effectively, substantial portions of the watch 100 are mounted about the exterior of the insert 10.

In order to use the insert or interface 10 of the present invention, the watch 100 is placed over the exterior of the insert 10 and one segment 54 of the band is inserted through one band opening 22 on one of the flanges and the other band segment 56 is inserted through the other band opening 22 in the other flange. The main body 50 of the watch 100 is positioned over the exterior surface of the web or pad 12. That is, the back of the main body 50 is aligned with the opening 18 and securely supported about the outer surface of the web 12. This means that the face 52 of the watch 100 lies generally parallel with the web 12. The band segments 54, 56 extend from the main body 50 of the watch 100 adjacent the exterior surfaces of the flanges 14 and 16 and, as noted above, a portion of the segments extend through the band openings 22.

Insert 10 and the watch 100 are then positioned on the forearm as shown in FIGS. 6 and 7. That is, the insert 10 is positioned about the forearm such that the main body 50 of the watch 100 is side mounted to the forearm. In this configuration, one of the flanges 14 or 16 extends across an upper surface of the forearm and the other one of the flanges 14 or 16 extends across the bottom or lower surface of the forearm. Thus, the web 12 is positioned over and engages the inner edge or side of the forearm. See FIGS. 6 and 7. Once the two band segments are fastened together and appropriately tensioned, this results in the insert 10 conforming and adhering to the forearm in this configuration. It also results in the face 52 of the watch being disposed in a line of sight that enables the person wearing the insert 10 and watch 100 to easily see and read information and data displayed on the face of the watch. That is, in most natural positions assumed by the forearm, while running, the information and data being displayed on the face of the watch can be easily seen and discerned without the person having to rotate the forearm so that the face of the watch is in a convenient line of sight.

The design of the insert 10 enables the insert to be held on the forearm with the web securely held around at least a portion of the inner edge of the forearm. Indeed, the inner surface of the web can be arcuate shaped or slightly concave to at least slightly conform to the shape of the inner edge of the forearm. Furthermore, the flanges 14 and 16 extending across the upper and lower surfaces of the forearm tend to stabilize the web in place adjacent the inner edge of the forearm. Once the insert 10 is coupled to the watch 100 and fastened about the forearm of a person, it follows that the watch is securely held about the insert and that substantial relative movement between the two is prevented. The tensioning of the watch band tends to clamp and compress the insert to the arm and this plays a role in securing the main body and face of the watch to the inner edge or side of the forearm. Thus, in the case of a running application, the runner typically swings his or her arms at least slightly back and forth and the forearm carrying the watch 100 tends to be disposed at an angle such that the inner edge or side of the forearm tends to face the line of slight of the runner.

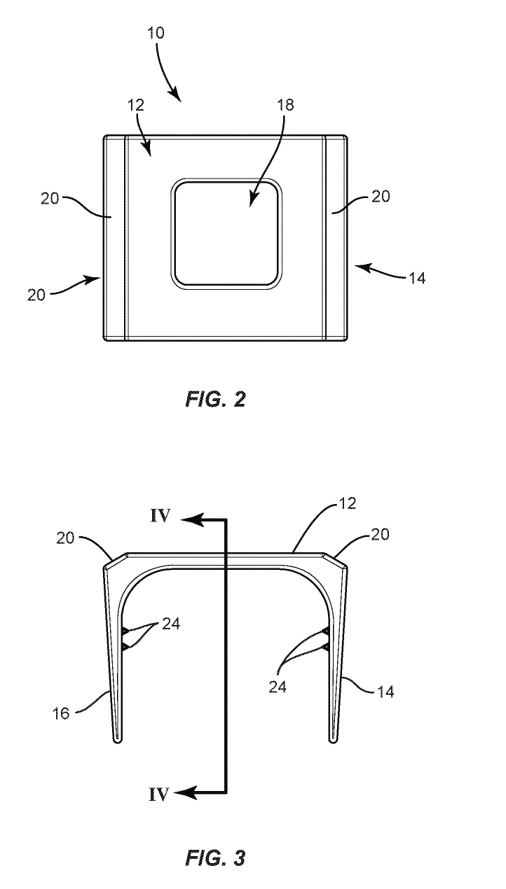

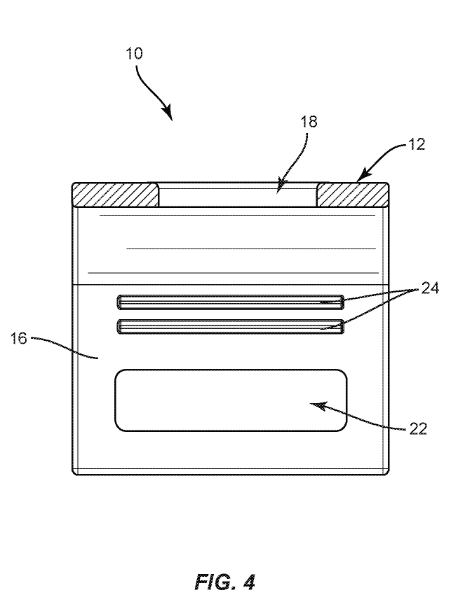

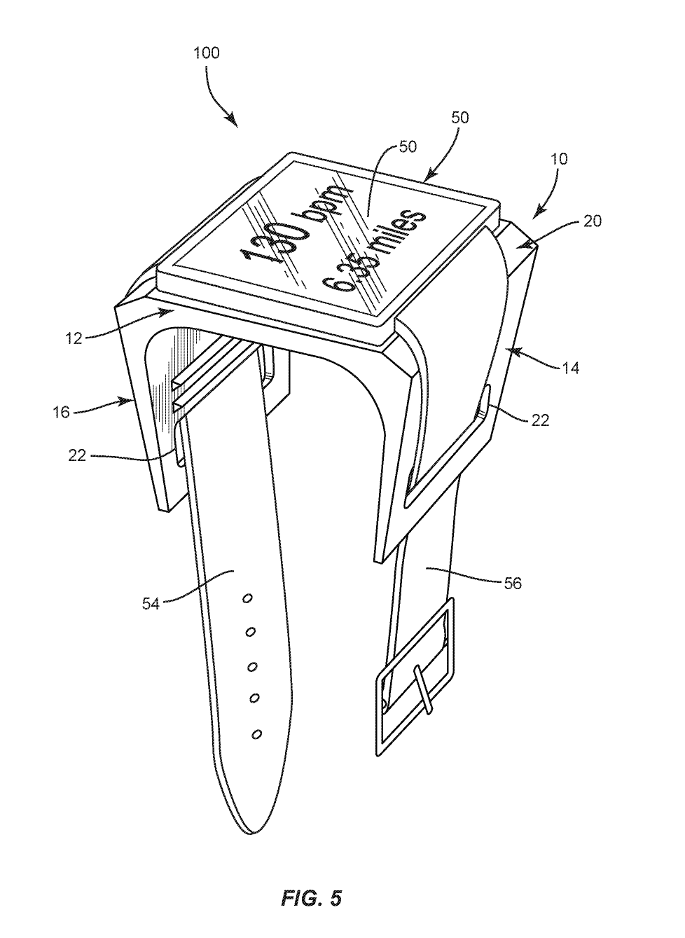

From a study of the present specification and the drawings, it is appreciated that there are several embodiments of the present invention. One embodiment includes the insert or interface 10 shown in FIGS. 1-4. In describing this embodiment, reference has been made to a watch for the purpose of giving context to the insert or interface 10 shown in FIGS. 1-4. A second embodiment is shown in FIG. 5. This embodiment comprises a combination. The combination is made up of the insert or interface 10 and a watch and, in certain cases, this combination has been specifically claimed.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. An insert for supporting a watch on the forearm of a person where the watch includes a main body and a band and wherein the insert enables the main body of the watch to be securely positioned on an inner side or edge of the forearm, the insert comprising:
a web;
a pair of flanges extending from the web; and
wherein the web and flanges are configured to attach to the watch such that the main body of the watch lies over the web and at least a portion of the band extends over outer sides of the flanges such that the web and flanges securely position the watch around the forearm such that the web and main body of the watch lie on the inner side or edge of the forearm.

2. The insert of claim 1 wherein the insert assumes a generally U-shape and is constructed of pliable material and wherein the flanges are flexible and configured to flex back and forth with respect to the web; and wherein the flanges include terminal ends that are spaced apart and wherein there is a gap defined between the terminal ends of the flanges that enable the forearm to be inserted through the gap and into the space at least partially defined by the flanges and web.

3. The insert of claim 1 wherein the flanges include a pair of band openings configured to receive the band and configured to permit the band to be inserted therethrough.

4. The insert of claim 1 wherein the web includes an opening configured to permit biometric data to be accessed by the main body of the watch.

5. The insert of claim 1 wherein the flanges are configured to flex back and forth with respect to the web.

6. The insert of claim 1 wherein the flanges include a pair of band openings configured to receive segments of the band; the web including an opening configured to permit biometric data to be transmitted through the opening; wherein the insert is constructed of a pliable material and wherein the flanges are configured to flex back and forth with respect to the web; and wherein the insert assumes a generally U-shaped configuration with the flanges including two terminal ends that are disposed in spaced apart relationship with respect to each other.

7. The insert of claim 1 wherein the insert forms a part of a combination and wherein the combination comprises the insert and the watch secured to the insert.

8. The insert according to claim 7 wherein the watch includes the main body and the band extending from the main body and wherein the main body is disposed on an exterior surface of the web and wherein at least a portion of the band extends over an exterior surface of the flanges.

9. The insert of claim 8 wherein the band of the watch includes two segments and wherein each segment of the band extends from the main body along an exterior surface of a respective flange and is threaded through an opening formed in a lower end portion of the respective flange; and wherein segments of the band project from the end portion of the flanges.

10. An interface for lying between a watch having a band and a forearm of a person for positioning a main body of the watch on an inner side or edge of the forearm for convenient viewing, the interface comprising:
an insert including a pad and first and second extensions that extends outwardly from opposite sides of the pad;
the pad configured to lie underneath and support the main body of the watch;
the extensions configured to lie underneath at least a portion of the band of the watch; and
the insert including means for positioning the pad on the inner side or edge of the forearm, whereby the main body of the watch lies adjacent the pad and positioned on the inner side or edge of the forearm.

11. The interface of claim 10 including means for coupling the insert to the watch.

12. The interface of claim 10 wherein the insert assumes a generally U-shaped configuration.

13. The interface of claim 12 wherein the U-shaped insert is configured to encircle a portion of the forearm such that the extensions extend across portions of the bottom and top of the forearm and the pad engages and lies on an inner side or edge of the forearm.

14. The interface of claim 10 wherein the interface forms a part of a combination and wherein the combination comprises the interface and the watch secured to the interface.

15. The interface of claim 14 wherein the watch includes the main body and the band extending from the main body and wherein the main body is disposed on an exterior surface of the pad and wherein at least a portion of the band extends over an exterior surface of the extensions.

16. A method of positioning a watch on a forearm of a person wherein the watch includes a main body and a band and the method includes positioning the main body of the watch on the inner side or edge of the forearm, the method comprising:
securing the watch to an insert having a web and a pair of flanges projecting the web;
positioning the watch on the insert such that the main body of the watch lies on an exterior surface of the web;
extending at least a portion of the band from the main body over an exterior portion of the flanges;
positioning the insert on the forearm by extending the flanges over upper and lower portions of the forearm and positioning the web on the inner side or edge of the forearm; and
securing the insert and watch to the forearm such that the main body of the watch is generally disposed on the inner side or edge of the forearm.

17. The method of claim 16 wherein the watch includes two band segments, and the method includes threading each band segment through an opening in the insert and thereafter coupling the two band sections.

18. The method of claim 17 including threading each band section through a transverse opening formed about an end portion of a respective flange.

19. The method of claim 18 wherein the insert underlies and supports the entire watch except for two band segment portions that project from inner sides of the flanges.
